(19) United States
(12) Patent Application Publication
(10) Pub. No.: US 2009/0136016 A1
(43) Pub. Date: May 28, 2009

(54) Transferring a communication event

(76) Inventors: Meelik Gornoi, Tabasalu (EE); Kaido Karner, Tallinn (EE); Priit Kasesalu, Tallinn (EE); Rain Johanson, Tallin (EE); Mart Oruaas, Tallinn (EE); Vigen Issahhanjan, Tallinn (EE)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 12/290,232

(22) Filed: Oct. 28, 2008

Related U.S. Application Data
(60) Provisional application No. 60/986,405, filed on Nov. 8, 2007.

(51) Int. Cl. H04M 3/42; H04L 12/66

(52) U.S. Cl. 379/212.01; 370/352

(57) ABSTRACT

A method of transferring a communication event from a calling user to at least one destination user is provided. The method comprises a communication client of the calling user establishing a connection with a communication client of an intermediate user over a packet-based communication network, the intermediate user selecting to transfer the connection to the at least one destination user by actuating a control displayed in the communication client of the intermediate user, the communication client of the intermediate user transmitting a message to the communication client of the calling user comprising at least one network identity of the at least one destination user, and the communication client of the calling user receiving the message and establishing a connection with a communication client of the at least one destination user using the network identity.

### RELATED APPLICATION

This application claims the benefit of U.S. Provisional Application No. 60/986,405, filed on Nov. 8, 2007. The entire teachings of the above application are incorporated herein by reference.

### TECHNICAL FIELD

This invention relates to transferring a communication event, particularly but not exclusively for use in packet-based communication networks.

### BACKGROUND

Packet-based communication systems allow the user of a device, such as a personal computer, to communicate across a computer network such as the Internet. Packet-based communication systems include voice over internet protocol (“VoIP”) communication systems. These systems are beneficial to the user as they are often of significantly lower cost than fixed line or mobile networks. This may particularly be the case for long-distance communication. To use a VoIP system, the user must install and execute client software on their device. The client software provides the VoIP connections as well as other functions such as registration and authentication. In addition to voice communication, the client may also provide further features such as video calling.

One type of packet-based communication system uses a peer-to-peer (“P2P”) topology built on proprietary protocols. To enable access to a peer-to-peer system, the user must execute P2P client software provided by a P2P software provider on their computer, and register with the P2P system. When the user registers with the P2P system the client software is provided with a digital certificate from a server. Once the client software has been provided with the certificate, communication can subsequently be set up and routed between users of the P2P system without the further use of a server. In particular, the users can establish their own communication routes through the P2P system based on the exchange of one or more digital certificates (or user identity certificates, “UIC”), which enable access to the P2P system. The exchange of the digital certificates between users provides proof of the users' identities and that they are suitably authorised and authenticated in the P2P system. Therefore, the presentation of digital certificates provides trust in the identity of the user. It is therefore a characteristic of peer-to-peer communication that the communication is not routed using a server but directly from end-user to end-user. Further details on such a P2P system are disclosed in WO 2005/009019.

However, packet-based communication systems lack many of the additional services offered by traditional telephone networks. This is particularly the case for the types of services required in a business environment, where private telephone networks are often deployed. This is because VoIP systems have generally been developed for end-users in the home environment. In a business environment, traditional telephone networks can utilise private branch exchanges (“PBX”) to implement services such as call transfer. A suitable localised central entity such as a PBX is not present in VoIP systems, particularly in P2P VoIP systems.

### SUMMARY

According to one aspect of the present invention there is provided a method of transferring a communication event from a calling user to at least one destination user, comprising:

a communication client of the calling user establishing a connection with a communication client of an intermediate user over a packet-based communication network;

the intermediate user selecting to transfer the connection to the at least one destination user by actuating a control displayed in the communication client of the intermediate user;

the communication client of the intermediate user transmitting a message to the communication client of the calling user comprising at least one network identity of the at least one destination user; and

the communication client of the calling user receiving the message and establishing a connection with a communication client of the at least one destination user using the network identity.

Preferably, the packet-based communication network is a voice over internet protocol network, and the communication clients are voice over internet protocol clients. In one embodiment, the communication event is a voice call. In another embodiment, the communication event is a video call. In one embodiment, the network identity is a username. In another embodiment, the network identity is a telephone number.

Preferably, the message comprises an identifier for the transfer. Preferably, the message further comprises a signed authentication token. The signed authentication token can comprise at least one of: a network identity for the calling user; a current network timestamp; text comprising a transfer topic; and the network identity of the at least one destination user.

The method may further comprise the step of the communication client of the calling user validating the message from the communication client of the intermediate user. Preferably, the step of validating comprises validating the signed authentication token.

Preferably, the step of the communication client of the calling user receiving the message and establishing a connection with a communication client of the at least one destination user using the network identity comprises the communication client of the calling user transmitting the signed authentication token to the communication client of the at least one destination user. Preferably, the method further comprises the step of the communication client of the at least one destination user validating the signed authentication token.

The method may further comprise the step of the communication client of the at least one destination user inheriting authorisation settings from the communication client of the intermediate user. Preferably, the authorisation settings from the communication client of the intermediate user are obtained from the signed authentication token.

The method may further comprise the step of the communication client of the calling user transmitting at least one transfer status message to the communication client of the intermediate user. The transfer status message may comprise a status field indicating the status of the connection between the communication client of the calling user and the communication client the at least one destination user. Preferably, the status field indicates at least one of: call connecting; call ringing; and call in progress. Preferably, responsive to the communication client of the intermediate user receiving a transfer status message indicating that the call is in progress, the connection between the communication client of the calling user and the communication client of the intermediate user is disconnected.

Preferably, in the case that the connection between the communication client of the calling user and the communication client of the at least one destination user cannot be established, a transfer aborted message is transmitted from the communication client of the calling user to the communication client of the intermediate user.

The step of the communication client of the calling user establishing a connection with a communication client of the at least one destination user may comprise establishing the connection with the one of the at least one users that answers the connection first.

Preferably, the packet-based communication network is a peer-to-peer voice over internet protocol communication network. Preferably, the control displayed in the communication client of the intermediate user is an option displayed in the user interface of the communication client.

According to another aspect of the present invention there is provided a system for transferring a communication event from a calling user to at least one destination user, comprising:

a calling user terminal executing a first communication client;

an intermediate user terminal executing a second communication client; and

at least one destination user terminal executing a third communication client,

wherein the first communication client is arranged to establish a connection with the second communication client over a packet-based communication network, the second communication client displays a control arranged to initiate a transfer of the connection to the at least one destination user terminal and is configured to transmit a message to the first communication client of the calling user terminal comprising at least one network identity of the at least one destination user, and the first communication client is arranged to receive the message and establish a connection with the third communication client of the at least one destination user terminal using the network identity.

Preferably, the packet-based communication network is a voice over internet protocol network, and the communication clients are voice over internet protocol clients. In one embodiment, the communication event is a voice call. In another embodiment, the communication event is a video call. In one embodiment, the network identity is a username. In another embodiment, the network identity is a telephone number.

Preferably, the message comprises an identifier for the transfer. Preferably, the message further comprises a signed authentication token. The signed authentication token can comprise at least one of: a network identity for the calling user; a current network timestamp; text comprising a transfer topic; and the network identity of the at least one destination user.

The first communication client may be further arranged to validate the message from the second communication client. Preferably, the step of validating comprises validating the signed authentication token.

The first communication client may be further arranged to transmit the signed authentication token to the third communication client. Preferably, the third communication client is arranged to validate the signed authentication token.

The third communication client may be arranged to inherit authorisation settings from the second communication client. Preferably, the authorisation settings from the second communication client are obtained from the signed authentication token.

The first communication client may be further arranged to transmit at least one transfer status message to the second communication client. Preferably, the transfer status message comprises a status field indicating the status of the connection between the first communication client and the third communication client. The status field may indicate at least one of: call connecting; call ringing; and call in progress. The second communication client may be arranged to disconnect the connection between the first communication client and the second communication client responsive to receiving a transfer status message indicating that the call is in progress.

The first communication client may arranged to transmit a transfer aborted message to the second communication client in the case that the connection between the first communication client and the third communication client cannot be established.

Preferably, the first communication client is arranged to establish the connection with the one of the at least one users that answers the connection first.

Preferably, the packet-based communication network is a peer-to-peer voice over internet protocol communication network. Preferably, the control displayed in the communication client of the intermediate user is an option displayed in the user interface of the second communication client.

According to another aspect of the present invention there is provided a user terminal for transferring a communication event from a calling user to at least one destination user, comprising:

a processor configured to execute a communication client, wherein the communication client is arranged to: establish a connection with a calling communication client of the calling user over a packet-based communication network; display a control arranged to initiate a transfer of the connection to a destination communication client of the at least one destination user; and transmit a message to the calling communication client comprising at least one network identity of the at least one destination user such that a connection between the calling communication client and the destination communication client is established using the network identity.

According to another aspect of the present invention there is provided a method of transferring a communication event from a calling user to at least one destination user at a user terminal executing a communication client, comprising:

the communication client establishing a connection with a calling communication client of the calling user over a packet-based communication network;

the communication client displaying a control arranged to initiate a transfer of the connection to a destination communication client of the at least one destination user; and

responsive to actuation of the control, the communication client transmitting a message to the calling communication client comprising at least one network identity of the at least one destination user, such that a connection between the calling communication client and the destination communication client is established using the network identity.

According to another aspect of the present invention there is provided a computer program product comprising program code means which, when executed by a computer implement the steps according to the above method.

### BRIEF DESCRIPTION OF THE DRAWINGS

For a better understanding of the present invention and to show how the same may be put into effect, reference will now be made, by way of example, to the following drawings in which:

FIG. 1 shows a P2P communication system;

FIG. 2 shows an example user interface of a client;

FIG. 3 shows a detailed view of a user terminal;

FIG. 4 shows a process for transferring a call;

FIGS. 5A to 5C show the user interfaces for a transferring party initiating a direct call transfer; and

FIGS. 6A to 6E show the user interfaces for a transferring party initiating a screening call transfer.

### DETAILED DESCRIPTION

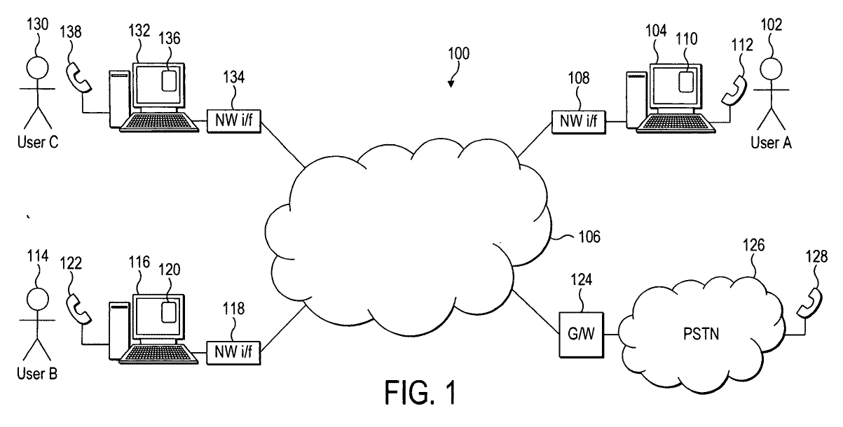

Reference is first made to FIG. 1, which illustrates a P2P communication system 100. Note that whilst this illustrative embodiment is described with reference to a P2P communication system, other types of communication system could also be used, such as non-P2P, VoIP systems. A first user of the P2P communication system (denoted “User A” 102) operates a user terminal 104, which is shown connected to a P2P network 106. Note that the P2P network 106 utilises a communication system such as the Internet. The user terminal 104 may be, for example, a personal computer (“PC”), personal digital assistant (“PDA”), a mobile phone, a gaming device or other embedded device able to connect to the P2P network 106. The user device is arranged to receive information from and output information to a user of the device. In a preferred embodiment of the invention the user device comprises a display such as a screen and a keyboard and mouse. The user device 104 is connected to the P2P network 106 via a network interface 108 such as a modem, and the connection between the user terminal 104 and the network interface 108 may be via a cable (wired) connection or a wireless connection.

The user terminal 104 is running a client 110, provided by the P2P software provider. The client 110 is a software program executed on a local processor in the user terminal 104. The user terminal 104 is also connected to a handset 112, which comprises a speaker and microphone to enable the user to listen and speak in a voice call. The microphone and speaker does not necessarily have to be in the form of a traditional telephone handset, but can be in the form of a headphone or earphone with an integrated microphone, or as a separate loudspeaker and microphone independently connected to the user terminal 104.

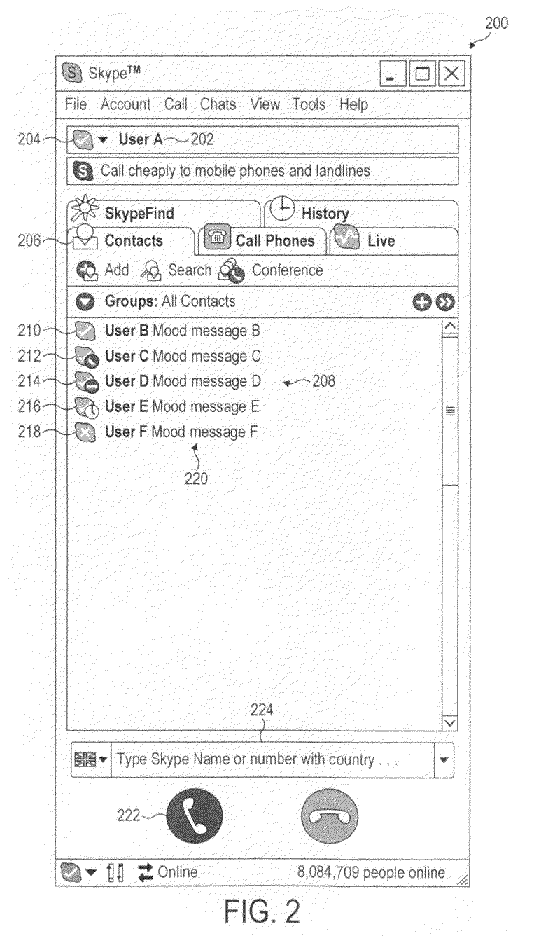

An example of a user interface 200 of the client 110 executed on the user terminal 104 of User A 102 is shown illustrated in FIG. 2. The client user interface 200 displays the username 202 of User A 102 in the P2P system, and User A can set his own presence state (that will be seen by other users) using a drop down list by selecting icon 204.

The client user interface 200 comprises a tab 206 labelled “contacts”, and when this tab is selected the contacts stored by the user in a contact list are displayed. In the example user interface in FIG. 2, five contacts of other users of the P2P system (User B to F) are shown listed in contact list 208. Each of these contacts have authorised the user of the client 110 to view their contact details, presence state and mood message information. Each contact in the contact list has a presence state chosen by the contact associated with it. For example, the presence status icon for User B 210 indicates that User B is “online”, the presence icon for User C 212 indicates that User C is “not available”, the presence icon for User D 214 indicates that User D's state is “do not disturb”, the presence icon for User E 216 indicates User E is “away”, and the presence icon for User F 218 indicates that User F is “offline”. Further presence indications can also be included. Next to the names of the contacts in pane 208 are the mood messages 220 of the contacts.

The contact list for the users (e.g. the contact list 208 for User A) is stored in a contact server (not shown in FIG. 1). When the client 110 first logs into the P2P system the contact server is contacted, and the contact list is downloaded to the user terminal 104. This allows the user to log into the P2P system from any terminal and still access the same contact list. The contact server is also used to store the user's own mood message (e.g. the mood message of User A 102) and a picture selected to represent the user (known as an avatar). This information can be downloaded to the client 110, and allows this information to be consistent for the user when logging on from different terminals. The client 110 also periodically communicates with the contact server in order to obtain any changes to the information on the contacts in the contact list, or to update the stored contact list with any new contacts that have been added. Presence information is not stored centrally in the contact server. Rather, the client 110 periodically requests the presence state for each of the contacts in the contact list 208 directly over the P2P system. Similarly, the current mood message for each of the contacts, as well as a picture (avatar) that has been chosen to represent the contact, are also retrieved by the client 110 directly from the respective clients of each of the contacts over the P2P system.

Calls to the P2P users in the contact list may be initiated over the P2P system by selecting the contact and clicking on a “call” button 222 using a pointing device such as a mouse. Alternatively, the call may be initiated by typing in the P2P identity of a contact in the field 224. Referring again to FIG. 1, the call set-up is performed using proprietary protocols, and the route over the network 106 between the calling user and called user is determined by the peer-to-peer system without the use of servers. For example, User 102 can call User B 114.

Following authentication through the presentation of digital certificates (to prove that the users are genuine subscribers of the P2P system—described in more detail in WO 2005/009019), the call can be made using VoIP. The client 110 performs the encoding and decoding of VoIP packets. VoIP packets from the user terminal 104 are transmitted into the network 106 via the network interface 108, and routed to a computer terminal 116 of the called party, User B 114, via a network interface 118. A client 120 (similar to the client 110) running on the user terminal 116 of User B 114 decodes the VoIP packets to produce an audio signal that can be heard by User B using the handset 122. Conversely, when User B 114 talks into handset 122, the client 120 executed on user terminal 116 encodes the audio signals into VoIP packets and transmits them across the network 106 to the user terminal 104. The client 110 executed on user terminal 104 decodes the VoIP packets from User B 114, and produces an audio signal that can be heard by the user of the handset 112.

The VoIP packets for calls between P2P users (such as 102 and 114) as described above are passed across the network 106 only, and the PSTN network is not involved. Furthermore, due to the P2P nature of the system, the actual voice calls between users of the P2P system can be made with no central servers being used. This has the advantages that the network scales easily and maintains a high voice quality, and the call can be made free to the users. Additionally, calls can also be made from the client (110, 120) using the P2P system to fixed-line or mobile telephones, by routing the call via a gateway 124, to the PSTN network 126 and to telephone equipment 128. Similarly, calls from fixed-line or mobile telephones (128) can be made to the P2P system via the PSTN 126 and gateway 124.

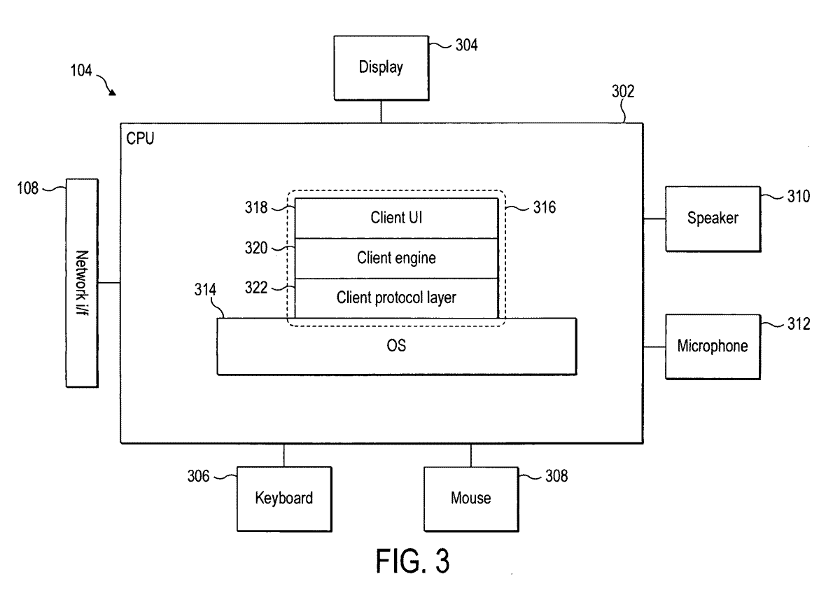

FIG. 3 illustrates a detailed view of the user terminal 104 on which is executed client 110. The user terminal 104 comprises a central processing unit (“CPU”) 302, to which is connected a display 304 such as a screen, an input device such as a keyboard 306, a pointing device such as a mouse 308, a speaker 310 and a microphone 312. The speaker 310 and microphone 312 may be integrated into a handset 112 or headset, or may be separate. The CPU 302 is connected to a network interface 108 as shown in FIG. 1.

FIG. 3 also illustrates an operating system (“OS”) 314 executed on the CPU 302. Running on top of the OS 314 is a software stack 316 for the client 110. The software stack shows a protocol layer 322, a client engine layer 320 and a client user interface layer (“UI”) 318. Each layer is responsible for specific functions. Because each layer usually communicates with two other layers, they are regarded as being arranged in a stack as shown in FIG. 3. The operating system 314 manages the hardware resources of the computer and handles data being transmitted to and from the network via the network interface 108. The client protocol layer 322 of the client software communicates with the operating system 314 and manages the connections over the P2P system. Processes requiring higher level processing are passed to the client engine layer 320. The client engine 320 also communicates with the client user interface layer 318. The client engine 320 may be arranged to control the client user interface layer 318 to present information to the user via the user interface of the client (as shown in FIG. 2) and to receive information from the user via the user interface.

It is desirable for a user of the P2P system 100 to be able to transfer a call that he has received to another user of the P2P system. This is particularly the case for business use, where a single user, such as a receptionist, needs to transfer incoming calls to the most appropriate user.

For example, User B 114 may wish to transfer a call from User A 102 to a third user, User C 130. User C 130 operates a user terminal 132 connected to the network 106 via a network interface 134. The user terminal 132 executes a client 136 similar to clients 110 and 120. A handset 138 is connected to the user terminal 132.

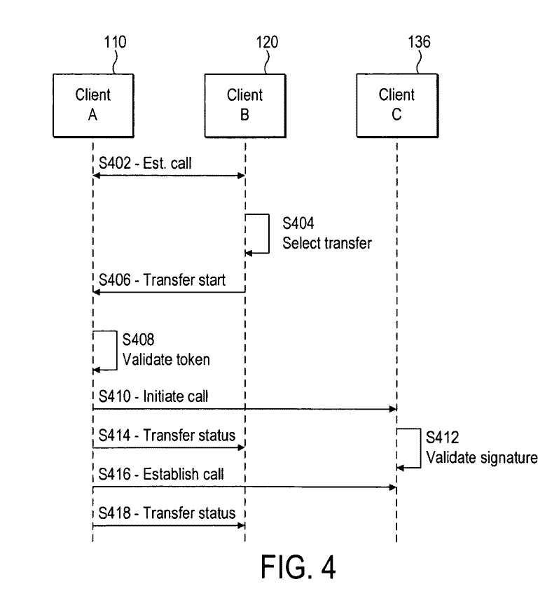

FIG. 4 illustrates the process by which a call from User A 102 can be transferred from User B 114 to User C 130. Note that FIG. 4 illustrates the scenario in which a call is from User A to User B, and then transferred to User C. In this example, all the users are VoIP users. Furthermore, there is only a single destination user, User C. In alternative embodiments, there may be multiple destination users. Furthermore, the destination of the transfer can also be a PSTN or mobile number.

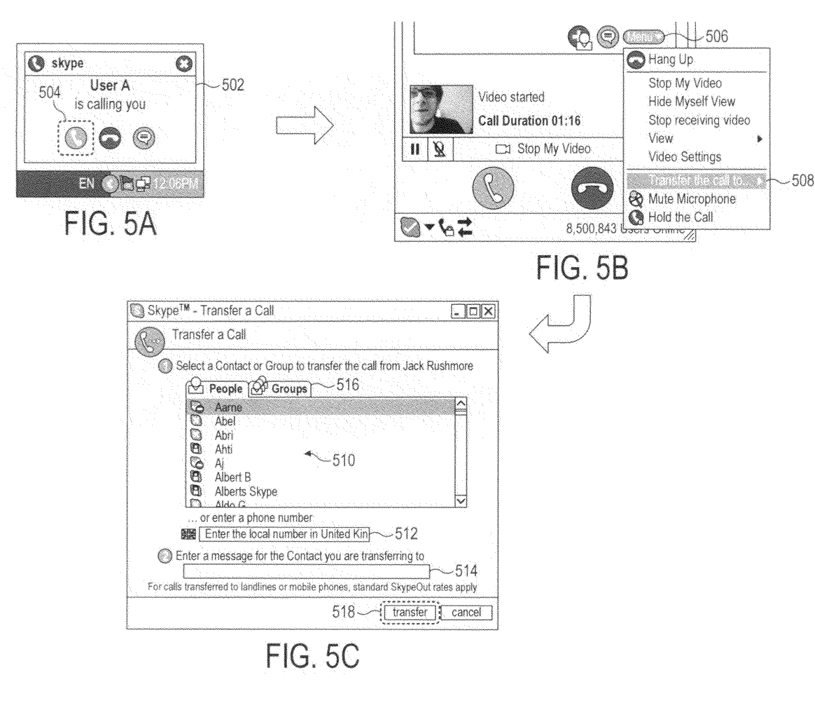

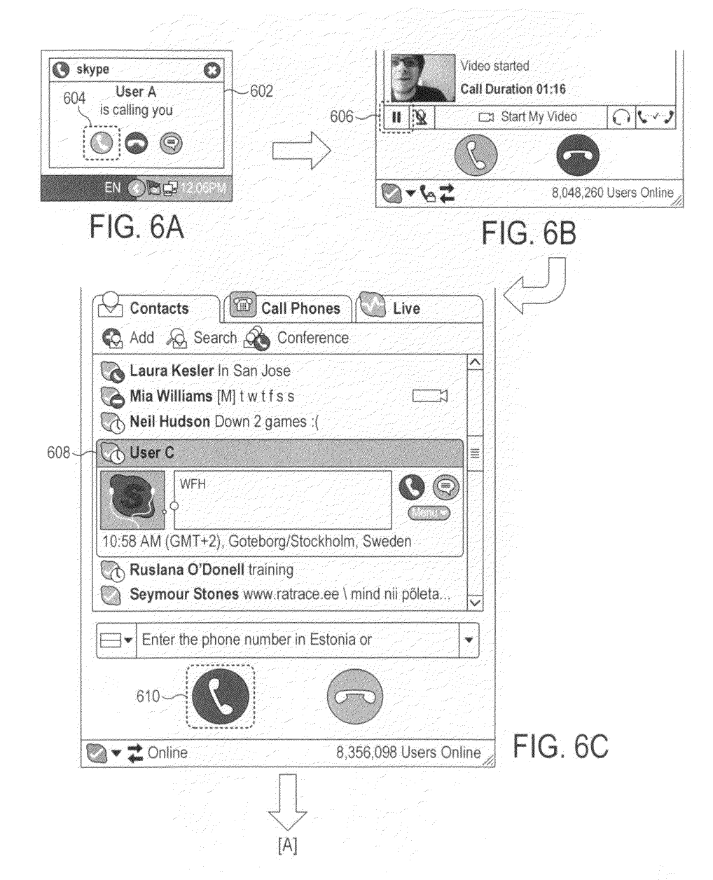

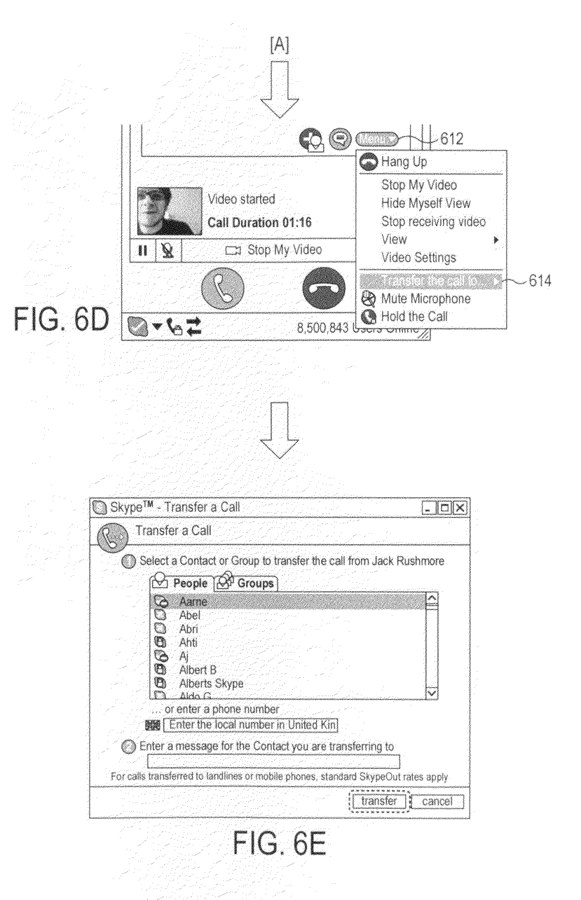

In step S402, the User A 102 uses the client 110 to establish a call with the client 120 of User B 114. In step S404, User B 114 uses the client 120 to select to transfer the call to User C 130. The user interface for selecting to transfer the call is illustrated in more detail in FIGS. 5 and 6. The transfer process can be started by User B 114 either when the call from User A 102 is ringing (i.e. connection established but not answered by User B), or when a call between User A 102 and User B 114 is in progress. In particular, if the call between User A 102 and User B 114 is in progress, the call transfer can be initiated either immediately by User B 114, or User A 102 can be put on hold before initiating the transfer (this is known as a screening transfer).

When User B 114 selects the option to transfer the call, a “transfer start” command is sent from the client B 120 to client A 110. This command includes the network identity of the user to which the call is being transferred. This can be in the form of User C's P2P username, or, alternatively, a PSTN telephone number can be specified. The “transfer start” command also includes a unique identifier for this transfer, and a digitally signed authentication token.

The signed authentication token is digitally signed using a private cryptographic key held by User B 114. This enables other users to validate that this token is indeed generated by User B 114. The authentication token contains the username of User A 102, the current time in the network, the unique identifier for this transfer, an optional text-based description of the reason for the transfer (entered by User B 114), and the network identity of User C 130.

Once the “transfer start” message of S406 is sent to User A 102, User B 114 can, if desired, go offline and transfer will continue on its own. However, for the purposes of the example in FIG. 4, User B 114 remains online.

When User A 102 receives the “transfer start” message, the client 110 first validates that its signature is valid in step S408. Then, in step S410, client 110 starts a call setup process to the user to which the call is being transferred, as specified in “transfer start” command. This uses the network identities from the “transfer start” message.

S410 is similar to a normal call setup, except an additional attribute is included in the call setup command. Specifically, the signed authentication token and unique transfer identifier are included in the call setup message.

When client C 136 receives the incoming call that includes the signed authentication token and transfer identifier, in step S412 it validates the signature to make sure that transfer was indeed performed by User B 114. Client C 136 verifies that network time in the token is current, and checks if the transfer identifier in the token has not been seen before. This ensures that the token can be used only once, and prevents the same token being used over and over again.

From the signed token, client C 136 also extracts User B's network identity and before accepting the call, it performs an authorisation check as if the caller was User B 114 (and not User A 102). Thus User A 102 inherits the authorisation settings of User B 114 for this call. This is performed because the privacy settings of User C 130 may be such that User C 130 is only able to receive calls from users that are present in User C's contact list, which he has authorised. User C 130 has authorised User B 114 to contact him (as he is present in User B's contact list), but may not have previously authorised User A 102 (or indeed may never have had any previous contact with User A). Therefore, a call between User A 102 and User C 130 could not normally be established. However, because this has been established though a trusted intermediary (User B 114) the authorisation settings are overruled by User A 102 inheriting the authorisation settings of User B 114, enabling the call to be established with User C 130.

During the transfer process, client A 110 sends several “transfer status update” messages to client B 120, assuming that User B 114 is still online. These messages comprise the status of the call transfer between User A 102 and User C 130. For example, these message state whether the transferred call is connecting, ringing, or in progress. If the transfer was made to multiple destinations also the actual destination that the transfer was answered on is included in this message. For example, whilst client C 136 is validating the signature in S412, client A 120 sends a “connecting” transfer status message to client B 120 in step S414.

In step S416, the call is established between User A 102 and User C 130. Following the establishment of the call User A 102 and User C 130, client A 110 transmits an “in progress” transfer status message to client B 120. Optionally, client B 120 can now drop any connections to client A 110, as the transfer has completed, or client B 120 can continue to receive status updates until the call between User A 102 and User C 130 ends.

If client A 110 is unable to establish connection to any of the transferred destinations (e.g. if User C does not pick up), client A 110 sends a “transfer abort” message to client B 120, and the call will go to a ringing state again, such that User B 114 can either answer the call again, or attempt to transfer it to a different destination. This is not illustrated in FIG. 4.

Reference is now made to FIGS. 5A to 5C which illustrate the user interfaces presented to the transferring party (i.e. User B 114 in this example) when performing a direct call transfer.

In FIG. 5A, User B 114 receives an alert 502 on his user terminal that User A 102 is calling him, and answers the call using the answer button 504. The call is then established between User A 102 and User B 114, and displayed in the client UI as shown in FIG. 5B. To transfer the call, User B 114 selects the button labelled “menu” 506, and selects the menu item labelled “Transfer the call to . . . ” 508. This displays a list comprising the five most recent transfers or calls. User B 114 can select one of these contacts or use the “Someone else . . . ” option to select another contact. Responsive to this, User B 114 is presented with the screen shown in FIG. 5C. This shows a list of the contacts 510 of User B 114, to whom the call can be transferred. Additionally, FIG. 5B shows a field for entering a PSTN number 512 to which the call can be transferred. Furthermore, a text entry field 514 allows User B 114 to enter a text message that will be displayed to the transferred user (i.e. User C 130) which can be used to explain why the call is being transferred. This can be useful, as User C 130 can decide whether or not to accept the transfer before being connected to User A 102. User B 114 can alternatively select a group of contacts to transfer the call to, by viewing the groups tab 516. The transfer is initiated by User B 114 selecting the “transfer” button 518.

Reference is now made to FIGS. 6A to 6E, which illustrate the user interfaces presented to the transferring party (i.e. User B 114) when performing a screening call transfer.

In FIG. 6A, User B 114 receives an alert 602 on his user terminal that User A 102 is calling him, and answers the call using the answer button 604. The call is then established between User A 102 and User B 114, and displayed in the client UI as shown in FIG. 6B. User B 114 puts User A 102 on hold using the hold button 606. In FIG. 6C, whilst User A 102 is on hold, User B 114 finds the contact 608 for the person to whom the call is to be transferred in the contact list (i.e. User C 130), and initiates a call to this user with button 610.

In FIG. 6D, the call between User B 114 and User C 130 is connected, and displayed in the UI of the client. User B 114 can talk to User C 130 to explain why User A 102 is calling, and to warn User C that the call is about to be transferred. To transfer the call, User B 114 selects the button labelled “menu” 612, and selects the menu item labelled “Transfer the call to . . . ” 614. This displays a list comprising the five most recent transfers or calls. Because User B 114 currently has User A 102 on hold, User A's name and/or number is at the top of this list, and can be selected to initiate the transfer. Alternatively, a different contact can be selected using the display in FIG. 6E, in a similar manner to that described with reference to FIG. 5C.

While this invention has been particularly shown and described with reference to preferred embodiments, it will be understood to those skilled in the art that various changes in form and detail may be made without departing from the scope of the invention as defined by the appendant claims.

For example, the call can be transferred to a PSTN or mobile telephone number. This is achieved by the transferring user entering the number into the field 512 shown in FIG. 5C. If the call is to be transferred to a PSTN or mobile number, then the process shown in FIG. 4 is slightly different, as User B 114 sends a “setup transfer” message to the gateway 124 shown in FIG. 1 with the destination telephone number(s) and receives a transfer identity back from the gateway 124. This transfer identity is sent with the “transfer start” message to client A 110 along with the gateway address.

Client A 110 then connects to the gateway 124, presents the transfer identity, and the call is connected to the destination telephone number(s). A signed token is not used in this case, as client B 120 has already told the gateway 124 that client A 110 will contact it.

Furthermore, the destination of the call transfer does not have to be a single endpoint. Rather it can contain multiple destinations. Additionally, this can be a mix of VoIP usernames and PSTN numbers. In the case of multiple destinations, client A 110 will start connecting to all destinations at the same time and the transfer will go through to the destination which picks up the call first.

While this invention has been particularly shown and described with references to example embodiments thereof, it will be understood by those skilled in the art that various changes in form and details may be made therein without departing from the scope of the invention encompassed by the appended claims.

What is claimed is:

1. A method of transferring a communication event from a calling user to at least one destination user, comprising:
a communication client of the calling user establishing a connection with a communication client of an intermediate user over a packet-based communication network;
the intermediate user selecting to transfer the connection to the at least one destination user by actuating a control displayed in the communication client of the intermediate user;
the communication client of the intermediate user transmitting a message to the communication client of the calling user comprising at least one network identity of the at least one destination user; and
the communication client of the calling user receiving the message and establishing a connection with a communication client of the at least one destination user using the network identity.

2. A method according to claim 1, wherein the packet-based communication network is a voice over internet protocol network, and the communication clients are voice over internet protocol clients.

3. A method according to claim 1, wherein the communication event is a voice call.

4. A method according to claim 1, wherein the communication event is a video call.

5. A method according to claim 1, wherein the network identity is a username.

6. A method according to claim 1, wherein the network identity is a telephone number.

7. A method according to claim 1, wherein the message comprises an identifier for the transfer.

8. A method according to claim 1, wherein the message comprises a signed authentication token.

9. A method according to claim 8, wherein the signed authentication token comprises at least one of: a network identity for the calling user; a current network timestamp; text comprising a transfer topic; and the network identity of the at least one destination user.

10. A method according to claim 8, wherein the method further comprises the step of the communication client of the calling user validating the message from the communication client of the intermediate user.

11. A method according to claim 10, wherein the step of validating comprises validating the signed authentication token.

12. A method according to claim 8, wherein the step of the communication client of the calling user receiving the message and establishing a connection with a communication client of the at least one destination user using the network identity comprises the communication client of the calling user transmitting the signed authentication token to the communication client of the at least one destination user.

13. A method according to claim 8, wherein the method further comprises the step of the communication client of the at least one destination user validating the signed authentication token.

14. A method according to claim 8, wherein the method further comprises the step of the communication client of the at least one destination user inheriting authorisation settings from the communication client of the intermediate user.

15. A method according to claim 14, wherein the authorisation settings from the communication client of the intermediate user are obtained from the signed authentication token.

16. A method according to claim 1, wherein the method further comprises the step of the communication client of the calling user transmitting at least one transfer status message to the communication client of the intermediate user.

17. A method according to claim 16, wherein the transfer status message comprises a status field indicating the status of the connection between the communication client of the calling user and the communication client the at least one destination user.

18. A method according to claim 17, wherein the status field indicates at least one of: call connecting; call ringing; and call in progress.

19. A method according to claim 16, wherein, responsive to the communication client of the intermediate user receiving a transfer status message indicating that the call is in progress, the connection between the communication client of the calling user and the communication client of the intermediate user is disconnected.

20. A method according to claim 1, wherein, in the case that the connection between the communication client of the calling user and the communication client of the at least one destination user cannot be established, a transfer aborted message is transmitted from the communication client of the calling user to the communication client of the intermediate user.

21. A method according to claim 1, wherein the step of the communication client of the calling user establishing a connection with a communication client of the at least one destination user comprises establishing the connection with the one of the at least one users that answers the connection first.

22. A method according to claim 1, wherein the packet-based communication network is a peer-to-peer voice over internet protocol communication network.

23. A method according to claim 1, wherein the control displayed in the communication client of the intermediate user is an option displayed in the user interface of the communication client.

24. A system for transferring a communication event from a calling user to at least one destination user, comprising:
a calling user terminal executing a first communication client;
an intermediate user terminal executing a second communication client; and
at least one destination user terminal executing a third communication client,
wherein the first communication client is arranged to establish a connection with the second communication client over a packet-based communication network, the second communication client displays a control arranged to initiate a transfer of the connection to the at least one destination user terminal and is configured to transmit a message to the first communication client of the calling user terminal comprising at least one network identity of the at least one destination user, and the first communication client is arranged to receive the message and establish a connection with the third communication client of the at least one destination user terminal using the network identity.

25. A system according to claim 24, wherein the packet-based communication network is a voice over internet protocol network, and the communication clients are voice over internet protocol clients.

26. A system according to claim 24, wherein the communication event is a voice call.

27. A system according to claim 24, wherein the communication event is a video call.

28. A system according to claim 24, wherein the network identity is a username.

29. A system according to claim 24, wherein the network identity is a telephone number.

30. A system according to claim 24, wherein the message comprises an identifier for the transfer.

31. A system according to claim 24, wherein the message comprises a signed authentication token.

32. A system according to claim 31, wherein the signed authentication token comprises at least one of: a network identity for the calling user; a current network timestamp; text comprising a transfer topic; and the network identity of the at least one destination user.

33. A system according to claim 31, wherein the first communication client is further arranged to validate the message from the second communication client.

34. A system according to claim 33, wherein the step of validating comprises validating the signed authentication token.

35. A system according to claim 31, wherein first communication client is further arranged to transmit the signed authentication token to the third communication client.

36. A system according to claim 31, wherein the third communication client is arranged to validate the signed authentication token.

37. A system according to claim 31, wherein the third communication client is arranged to inherit authorisation settings from the second communication client.

38. A system according to claim 37, wherein the authorisation settings from the second communication client are obtained from the signed authentication token.

39. A system according to claim 24, wherein the first communication client is further arranged to transmit at least one transfer status message to the second communication client.

40. A system according to claim 39, wherein the transfer status message comprises a status field indicating the status of the connection between the first communication client and the third communication client.

41. A system according to claim 40, wherein the status field indicates at least one of: call connecting; call ringing; and call in progress.

42. A system according to claim 39, wherein the second communication client is arranged to disconnect the connection between the first communication client and the second communication client responsive to receiving a transfer status message indicating that the call is in progress.

43. A system according to claim 24, wherein the first communication client is arranged to transmit a transfer aborted message to the second communication client in the case that the connection between the first communication client and the third communication client cannot be established.

44. A system according to claim 24, wherein the first communication client is arranged to establish the connection with the one of the at least one users that answers the connection first.

45. A system according to claim 24, wherein the packet-based communication network is a peer-to-peer voice over internet protocol communication network.

46. A system according to claim 24, wherein the control displayed in the second communication client is an option displayed in the user interface of the second communication client.

47. A user terminal for transferring a communication event from a calling user to at least one destination user, comprising:
a processor configured to execute a communication client, wherein the communication client is arranged to: establish a connection with a calling communication client of the calling user over a packet-based communication network; display a control arranged to initiate a transfer of the connection to a destination communication client of the at least one destination user; and transmit a message to the calling communication client comprising at least one network identity of the at least one destination user such that a connection between the calling communication client and the destination communication client is established using the network identity.

48. A method of transferring a communication event from a calling user to at least one destination user at a user terminal executing a communication client, comprising:
the communication client establishing a connection with a calling communication client of the calling user over a packet-based communication network;
the communication client displaying a control arranged to initiate a transfer of the connection to a destination communication client of the at least one destination user; and
responsive to actuation of the control, the communication client transmitting a message to the calling communication client comprising at least one network identity of the at least one destination user, such that a connection between the calling communication client and the destination communication client is established using the network identity.

49. A computer program product comprising program code means which, when executed by a computer implement the steps according to the method of claim 48.
